(19) United States
(12) Patent Application Publication
(10) Pub. No.: US 2008/0304527 A1
(43) Pub. Date: Dec. 11, 2008

(54) Controlling a bias current for an optical source

(76) Inventors: Miaobin Gao, Saratoga, CA (US); Darren Crews, Santa Clara, CA (US); Chien-Chang Liu, Sunnyvale, CA (US)

Correspondence Address: TROP PRUNER & HU, PC, 1616 S. VOSS ROAD, SUITE 750, HOUSTON, TX, 77057-2631, US

(21) Appl. No.: 11/810,746

(22) Filed: Jun. 7, 2007

(51) Int. Cl. H01S 3/00

(52) U.S. Cl. 372/38.02

(57) ABSTRACT

In one embodiment, the present invention includes an apparatus having a current mirror with a current source coupled to a first terminal and an output current to flow from an output terminal, a laser coupled to the output terminal to be biased by the output current, and a comparator to compare a voltage of the first terminal to the voltage of the output terminal and gate the current mirror based on the comparison. Other embodiments are described and claimed.

### BACKGROUND

Lasers are used in a wide variety of applications. In particular, lasers are integral components in optical communication systems where a beam modulated with vast amounts of information may be communicated great distances at the speed of light over optical fibers.

Many systems include a so-called vertical cavity surface emitting laser (VCSEL). As the name implies, this type of laser is a semiconductor micro-laser diode that emits light in a coherent beam orthogonal to the surface of a fabricated wafer. VCSELs are compact, relatively inexpensive to fabricate in mass quantities, and may offer advantages over edge emitting lasers. Lasers such as a VCSEL are widely used in optical transceivers. Typically, a laser has a direct current (DC) bias current, which maintains the laser on so that a power up process is not needed when optical data is to be sent, providing for high speed communications. Thus when a laser is used in a fast switching application, the laser may be biased slightly above a threshold value to avoid a turn-on delay. This bias current thus may be used to maintain the laser above its threshold and in its linear operating region. Above this DC level, there is an alternating current (AC) current applied, having a level that depends on a signal level, which may be either “high” or “low” in a binary implementation.

To provide the DC bias current to the laser, a bias circuit may be used. When the bias current generated increases, as may occur due to an inexact matching of bias circuit components, a voltage drop across the laser also increases. Thus in turn can cause a change in the operating region of an active device in the bias circuit, which can cause the bias current to become voltage dependent, based on a voltage of the active device. Such voltage dependency can lead to imprecise control of the bias current, thus introducing non-linearity and unpredictability.

### BRIEF DESCRIPTION OF THE DRAWINGS

FIG. 1 is a block diagram of an optical transceiver in accordance with an embodiment of the present invention.

FIG. 2 is a schematic diagram of a bias circuit in accordance with one embodiment of the present invention.

FIG. 3 is a graphical illustration of bias current versus voltage in accordance with an embodiment of the present invention.

FIG. 4 is a block diagram of a system in accordance with one embodiment of the present invention.

### DETAILED DESCRIPTION

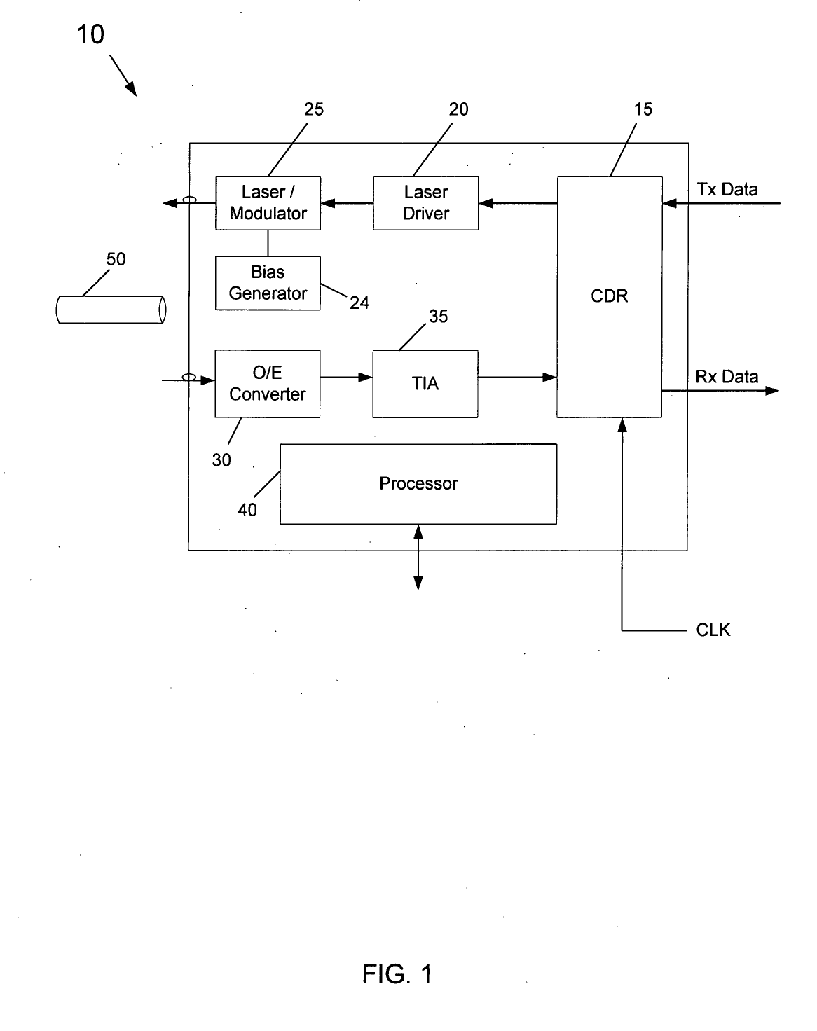

Referring now to FIG. 1, shown is a block diagram of an optical transceiver in accordance with an embodiment of the present invention. Transceiver 10 may act as an interface between a physical layer and a data link layer of a data communications system. As shown in FIG. 1, transceiver 10 may be used to receive and transmit optical information from/to an optical fiber 50. In turn, received data may be converted to electrical energy and provided to other portions of a system via a system interface as received data (RX Data). Similarly, incoming electrical energy corresponding to data to be transmitted (TX Data) may be received from the system and converted to optical energy for transmission via optical fiber 50.

Thus as shown in FIG. 1, transceiver 10 includes in a transmit direction a clock and data recovery circuit (CDR) 15 that receives data along with a reference clock (CLK) and provides the data to a laser driver 20 which in turn drives a laser/modulator 25, which may be a VCSEL in one embodiment, to convert the electrical data to optical data for transmission via optical fiber 50. Note further a bias generator 24 may be coupled to laser/modulator 25 to provide a bias current thereto, as will be described herein. Transceiver 10 includes in a receive direction an optical/electrical (O/E) converter 30 which may, in one embodiment be a positive intrinsic negative (PIN) diode or an avalanche photodetector (APD). The converted electrical energy may be provided to a transimpedance amplifier (TIA) 35 which converts the current into an electrical voltage. This amplified signal may be provided to CDR 15 to convert analog input data to a digital bitstream with an associated clock (i.e., CLK). In turn the data may be provided to other portions of a system as RX Data.

Note further the transceiver 10 of FIG. 1 may also include a processor 40 to handle control operations as well as to provide an interface for management and/or diagnostic information. In one embodiment, transceiver 10 may be formed as an integrated circuit (IC) on a single substrate, although the scope of the present invention is not limited in this regard. While shown with this particular implementation in the embodiment of FIG. 1, the scope of the present invention is not limited in this regard.

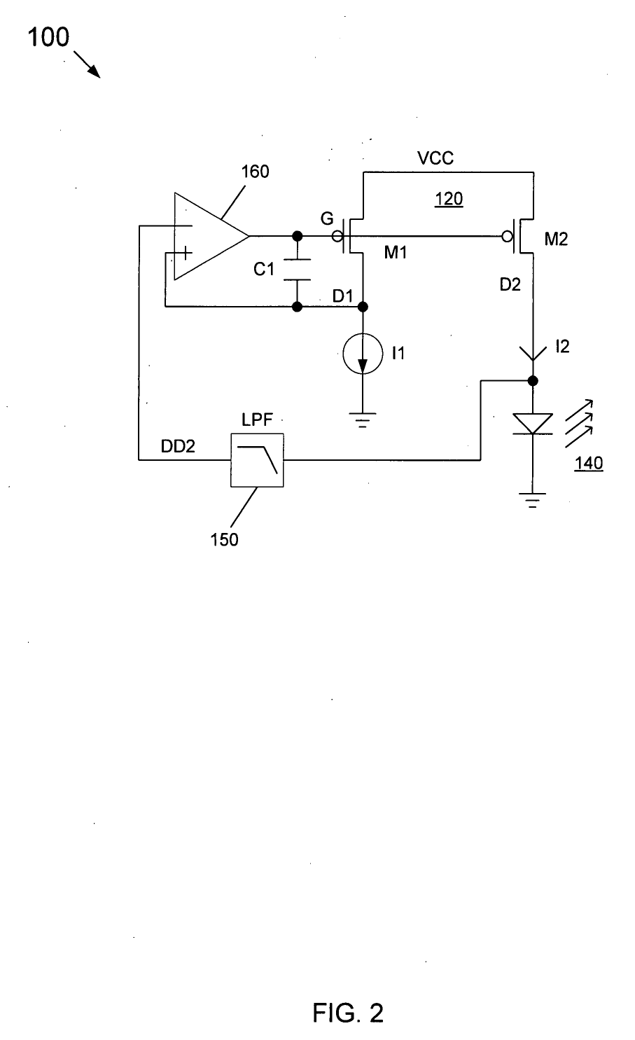

Referring now to FIG. 2, shown is a schematic diagram of a bias circuit in accordance with one embodiment of the present invention. As shown in FIG. 2, bias circuit 100 may be used to provide bias current precision control using negative feedback. Specifically, as shown in FIG. 2, a current mirror 120 includes a first transistor M1, which may be a p-channel metal oxide semiconductor field effect transistor (pMOSFET), and a second pMOSFET M2. The current mirror is configured such that a value of a current source I1 coupled to a drain terminal of transistor M1 is amplified to provide a bias current I2 to a laser 140 (e.g., a VCSEL) via a drain terminal of transistor M2. In one embodiment, transistor M2 may have a size of approximately 10 times that of transistor M1 such that bias current 12 is approximately 10 times the value of current source I1. By providing a current mirror having this relatively small ratio (i.e., 1:10) rather than a much larger ratio (e.g., 1:20 or greater), transistor M2 may be sized having a channel length corresponding to a smallest length offered at a given technology node, allowing for maximum speed of communication. In one embodiment, I1 may correspond to a current of approximately 1 milliampere (mA) and 12 may correspond to 10 mA, although the scope of the present invention is not limited in this regard.

Also shown in FIG. 2, source terminals of transistors M1 and M2 are coupled to a supply voltage, i.e., VCC, and both transistors M1 and M2 have commonly coupled gate terminals that receive a voltage from a comparator 160 which, in one embodiment may be an operational amplifier. Comparator 160 may perform a comparison based on voltages received at a pair of input terminals, namely a positive input terminal and a negative input terminal. As shown in FIG. 2, the positive input terminal is coupled to receive a voltage from a node D1, which is coupled to the drain terminal of transistor M1. The negative input terminal is coupled to receive a voltage DD2 at an output of a low pass filter (LPF) 150, which receives the voltage from a node D2 at the drain terminal of transistor M2. Accordingly, LPF 150 acts to filter out the AC portion of the input to laser 140 (i.e., corresponding to signal information, the source of which is not shown in FIG. 2) and provide the DC voltage present at node D2. Comparator 160 operates to compare these two voltages. In one embodiment, LPF 150 may be formed of a resistor-capacitor (RC) network, which may be integrated on a semiconductor substrate, such as a substrate that includes the remainder of bias circuit 10, along with laser 140.

Referring still to FIG. 2, a capacitor C1 may be coupled between the output node of comparator 160 and node D1 to compensate the negative feedback so that a phase margin remains above a stability requirement.

Using bias circuit 100 of FIG. 2, the bias current may be substantially independent of the voltage at node D2. That is, by the comparison operation performed by bias circuit 100, once the drain voltage of transistor M1, i.e., at node D1 tracks the drain voltage of transistor M2, i.e., the voltage at node D2, bias current 12 remains substantially constant and voltage independent. In contrast, in the presence of a current mirror without a comparison circuit as provided in the embodiment of FIG. 2, when the bias current increases a voltage drop across the laser increases, in turn reducing a voltage headroom of the output transistor of a current mirror (such as transistor M2 of FIG. 2). As the bias current reaches a certain limit (i.e., the drain voltage of the output transistor increases to a certain limit), the output transistor is pushed into a linear region and the bias current becomes voltage dependent.

Instead, using the embodiment of FIG. 2, the current mirror ratio between M1 and M2 remains constant regardless of a voltage drop from source to drain of transistor M2 or the laser voltage drop. Accordingly, embodiments provide a bias current that remains substantially constant and independent of voltage issues such as a voltage drop across an output transistor or the laser itself. Thus using embodiments of the present invention, a voltage drop across a laser or other optical source may vary, yet a bias current provided to drive the optical source may be substantially constant and independent of the varying voltage drop. Accordingly, an optical signal output by the laser may also be of a substantially constant amplitude. While shown in the embodiment of FIG. 2 with pMOSFETs and a common-cathode laser, in other implementations an optical source may be a common-anode configuration and the transistors of the current mirror may be formed of n-channel MOSFETs.

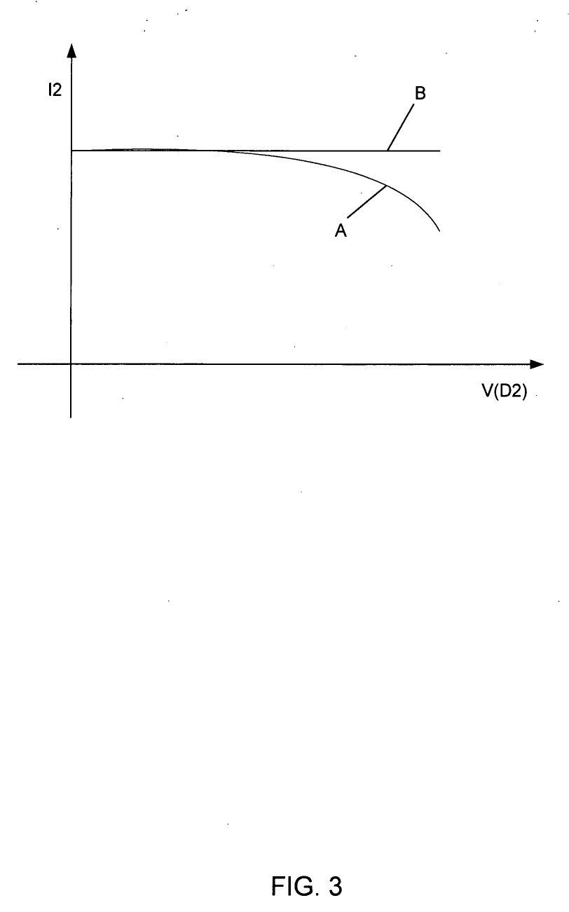

Referring now to FIG. 3, shown is a graphical illustration of bias current versus voltage. As shown in FIG. 3, using embodiments of the present invention such as bias circuit 100 of FIG. 2, a substantially steady bias current 12 is generated and provided to an optical source such as a laser, regardless of variance in voltage present at an output terminal of a current mirror or other current generator. Thus with reference back to FIG. 2, as the voltage at node D2 varies, bias current 12 provided to laser 140 may remain substantially constant, as shown at line B. In contrast, in a conventional biasing scheme as shown in curve A of FIG. 3, with varying voltage at the output terminal of the current mirror, the bias current may vary. Specifically, for greater voltages, the bias current decreases as shown at curve A.

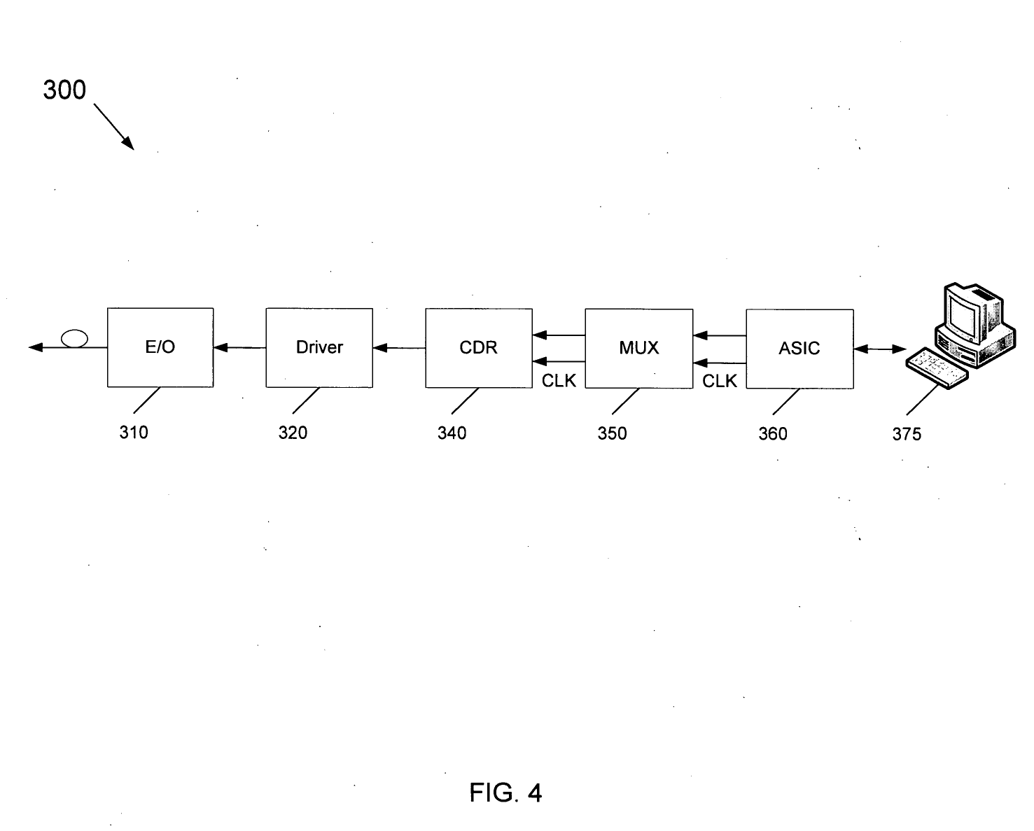

Referring now to FIG. 4, shown is a block diagram of a system in accordance with one embodiment of the present invention. As shown in FIG. 4, system 300 may include a line card or other switching device used in, for example, a high speed optical network, such as a metro area network (MAN), a local area network (LAN) or a wide area network (WAN). As shown in FIG. 4, system 300 may be used to transmit optical signal information along, e.g., an optical fiber. Data to be transmitted may be generated in a computer system 375. Digital data may be provided to an application specific integrated circuit (ASIC) 360, such as a media access control (MAC) module. ASIC 360 may code the data accordingly and provide it along with a clock signal to a multiplexer 350, which may convert parallel data received at a first frequency to a serial high-speed data stream, e.g., at a much higher frequency. In one embodiment, multiplexer 350 may take four or more parallel data streams and transform the data into a serial data signal. The serial data stream may then be provided to a CDR 340 to convert the digital bit stream at an associated clock rate into an analog input signal that includes the embedded clock signal. From CDR 340, the analog signal may be provided to a driver 320. Note that driver 320 may further include bias circuitry in accordance with an embodiment of the present invention. Accordingly, a drive signal which may include modulated signal information as well as a bias current source may be provided to an electrical-to-optical (E/O) converter 310, which may correspond to a laser or other optical source. O/E converter 310 may convert the incoming electrical energy to optical energy for transmission along an optical fiber.

Note that various components shown in FIG. 4 may form a line card that serves as an interface between an optical fiber line and system 375. Such a line card may also include components to receive and process optical signals received from the optical fiber, such as a photodetector, amplifiers, demultiplexers and so forth. While shown with this particular implementation in the embodiment of FIG. 4, understand the scope of the present invention is not limited in this regard.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a current mirror having a current source coupled to a first terminal and an output current to flow from an output terminal;
a laser coupled to the output terminal, the laser to be biased by the output current; and
a comparator to compare a voltage of the first terminal to a voltage of the output terminal, wherein an output of the comparator is to gate the current mirror.

2. The apparatus of claim 1, further comprising a filter coupled between the output terminal and a negative input terminal of the comparator.

3. The apparatus of claim 2, wherein the filter comprises a low pass filter to provide a value of a direct current (DC) voltage of the output terminal.

4. The apparatus of claim 2, wherein the comparator is to receive the voltage of the first terminal at a positive input terminal and to generate a control signal to cause the voltage of the first terminal to track an average voltage of the output terminal.

5. The apparatus of claim 4, further comprising a capacitor coupled between an output of the comparator and the positive input terminal of the comparator.

6. The apparatus of claim 4, wherein the comparator comprises an operational amplifier.

7. The apparatus of claim 5, wherein the apparatus comprises an optical transceiver formed on a substrate including the current mirror, the comparator, the capacitor, and the laser, the laser corresponding to a vertical cavity surface emitting laser.

8. The apparatus of claim 1, wherein the current mirror comprises a first transistor and a second transistor having commonly coupled gate terminals and commonly coupled source terminals, wherein the second transistor is sized to be N times larger than the first transistor, and wherein the output current is to be substantially independent of a voltage drop of the laser.

9. The apparatus of claim 3, wherein the DC voltage is provided to the negative input terminal of the comparator to provide a negative feedback signal thereto.

10. The apparatus of claim 9, wherein the output current is to remain substantially constant and independent of the DC voltage.

11. A method comprising:
comparing a first voltage of a first terminal of a current mirror with a direct current (DC) voltage of a second terminal of the current mirror;
controlling the current mirror based on the comparison; and
biasing an optical source with a bias current flowing from the second terminal.

12. The method of claim 11, further comprising filtering a voltage of the second terminal to obtain the DC voltage and providing the DC voltage to a comparator for the comparison.

13. The method of claim 11, further comprising biasing a laser of an optical transceiver with the bias current, the laser corresponding to the optical source.

14. The method of claim 11, further comprising maintaining the bias current substantially constant by the comparing and the controlling.

15. The method of claim 14, wherein the bias current is substantially independent of the DC voltage of the second terminal and a voltage drop of the optical source.

16. The method of claim 11, further comprising providing the DC voltage to a negative input terminal of a comparator and providing the first voltage to a positive input terminal of the comparator and providing an output of the comparator to gate terminals of the current mirror to control the current mirror.

17. A system comprising:
an optical transceiver including:
a bias circuit including a current mirror having a current source coupled to a first terminal of a first transistor and an output current to flow from a first terminal of a second transistor, and a comparator to compare a voltage of the first terminal of the first transistor to a direct current (DC) voltage of the first terminal of the second transistor, wherein an output of the comparator is to gate the current mirror;
a laser coupled to the first terminal of the second transistor, the laser to be biased by the output current; and
a clock and data recovery circuit (CDR) coupled to the laser, wherein the CDR is to provide an alternating current (AC) signal to the laser to provide data thereto; and
a multiplexer coupled to the optical transceiver to provide a serial data stream and a clock signal to the CDR.

18. The system of claim 17, further comprising a line card including the optical transceiver and the multiplexer.

19. The system of claim 17, wherein the bias circuit further comprises a low pass filter to provide the DC voltage to the comparator, wherein the comparator is to generate a control signal to cause the voltage of the first terminal of the first transistor to track the DC voltage.

20. The system of claim 19, wherein the first and second transistors have commonly coupled gate terminals and commonly coupled source terminals, and wherein the second transistor is sized to be N times larger than the first transistor.
